(19) United States
(12) Patent Application Publication
(10) Pub. No.: US 2003/0062442 A1
(43) Pub. Date: Apr. 3, 2003

(54) VTOL personal aircraft

(76) Inventor: Karl F. Milde JR., Mahopac, NY (US)

Correspondence Address: Karl F. Milde, Jr., Esq., MILDE, HOFFBERG & MACKLIN, L.L.P., Suite 460, 10 Bank Street, White Plains, NY, 10606, US

(21) Appl. No.: 09/968,934

(22) Filed: Oct. 2, 2001

(51) Int. Cl. B64C 15/02; B64C 29/00

(52) U.S. Cl. 244/12.3

(57) ABSTRACT

A personal aircraft (PAC) capable of vertical take-off and landing (VTOL) comprises a passenger compartment having a front, a rear and two sides, and a plurality of independently powered thrusters attached to the outer periphery of the compartment. At least three thrusters are disposed on each side of the compartment. The thrusters, which are preferably ducted fan units, are capable of providing a vertically upward force to the compartment.

### BACKGROUND OF THE INVENTION

The present invention relates to a personal aircraft (PAC) which is capable of taking-off and landing vertically, as well as hovering, if desired.

A PAC of this type is disclosed in the U.S. Pat. No. 6,179,247, which patent is incorporated herein by reference. This patent discloses a saucer-shaped personal air transport (PAT) having a plurality of “thrusters” arranged in a circle.

Whereas a craft of this type is capable of maneuvering forward and back, as well as side to side, its forward speed is somewhat limited by the drag induced by its relatively large cross-section. Also, since this craft is wingless, a considerable amount of energy, and thus fuel, is required to keep it aloft.

A more fuel efficient configuration has been developed by Moller International Corp. of Davis, Calif. (WWW.MOLLER.COM). This configuration, called the “Skycar”, is powered by four ducted fan units, two on each side of a passenger compartment or fuselage. The fuselage is aerodynamically shaped to permit high speed (up to 500 MPH) travel with reasonable fuel efficiency.

One major disadvantage of the Skycar is that it requires the thrust of all four ducted fan units to remain aloft. If one of these fan units or “thrusters” fails, the craft will fall from the sky.

Further, the lift provided by the fuselage and other parts of the craft at forward speeds is insufficient to maintain the craft aloft at relatively low forward speeds. Consequently, the Skycar requires a continuous upward force to be applied to the craft by the four ducted fans.

### SUMMARY OF THE INVENTION

It is an object of the present invention to improve the safety of a vertical take-off and landing (VTOL) aircraft of the type described above.

It is a further object of the present invention to improve the fuel efficiency of a VTOL aircraft of the type described above.

These objects, as well as other further objects which will become apparent from the discussion that follows, are achieved, in accordance with the present invention, by providing a personal aircraft (PAC) which comprises:

(a) a passenger compartment having a front, a rear and two sides; and

(b) a plurality of independently powered thrusters attached to the outer periphery of the compartment, with at least three thrusters disposed on each side of the compartment, to provide a vertically upward force to the compartment.

In this way, if one of the thrusters on each side were to fail, the remaining thrusters would maintain the craft aloft.

According to a particular feature of the invention, at least one of the thrusters on each side may be tilted to adjust the direction of force applied to the passenger compartment. In this way, either a forward or reverse force may be applied to the compartment in addition to the upwardly directed force.

According to a further feature of the invention, an additional independently powered thruster is attached to the compartment at the front, the rear, or both the front and rear, to exert a horizontal force to the compartment; e.g., in the forward direction.

According to another preferred feature of the present invention, the aircraft is provided with at least one substantially horizontal wing on each side of the passenger compartment to provide a lifting force during forward movement of the craft. Preferably, there are at least a pair of main wings plus a pair of control wings, such as a canard.

Finally, according to a preferred feature of the present invention, the PAC is provided with a parachute, attached to the top of the passenger compartment, and means for deploying the parachute in case of an emergency.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a perspective view of a personal aircraft (PAC) according to the preferred embodiment of the present invention.

FIG. 2 is a top view of the PAC of FIG. 1.

FIG. 3 is a side view of the PAC of FIG. 1.

FIG. 4 is a front view of the PAC of FIG. 1.

### DETAILED DESCRIPTION OF THE PREFERRED EMBODIMENT

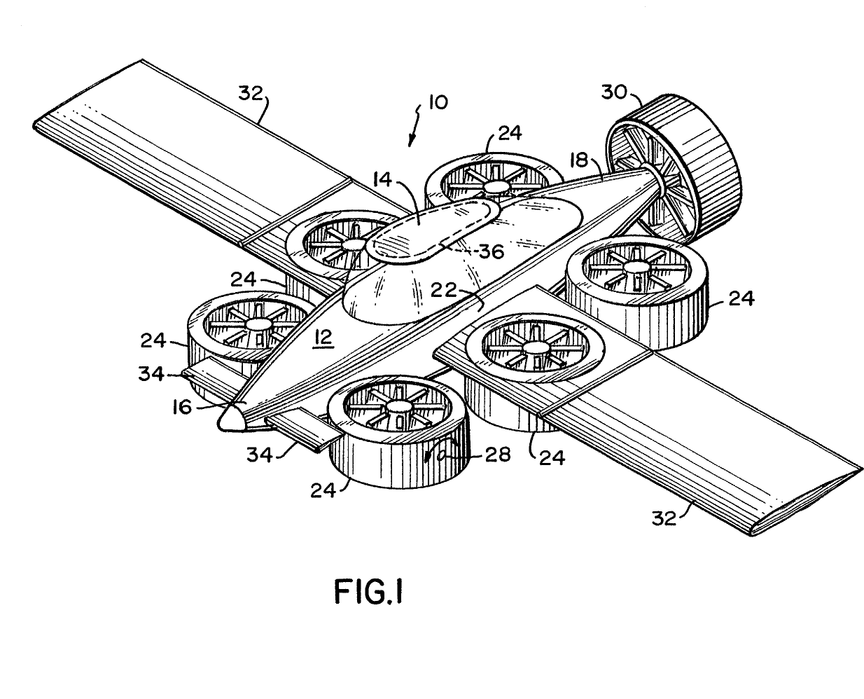

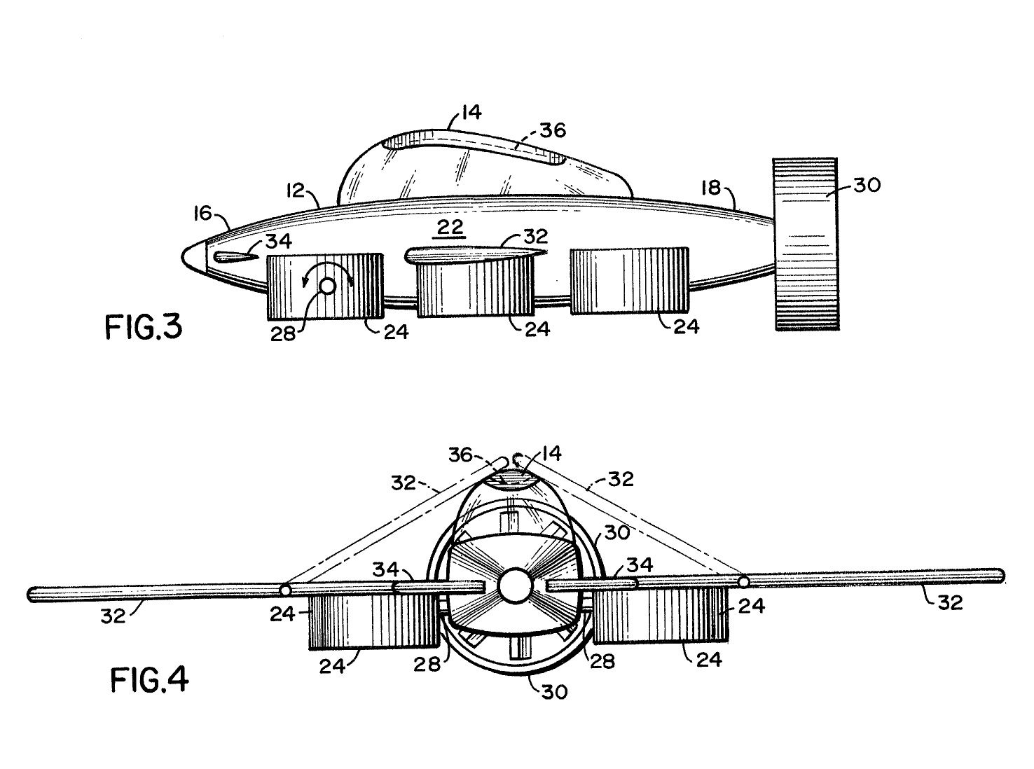

The preferred embodiment of the present invention will now be described with reference to FIGS. 1-4 of the drawings. Identical elements in the various figures are identified with the same reference numerals.

As shown in the figures, the personal aircraft (PAC) 10 comprises a passenger compartment or fuselage 12 having a top 14, a front 16, a rear 18 and two sides 20 and 22, respectively. Attached to each side of the compartment are three “thrusters” 24, preferably ducted fan units. These fan units may, for example, be the type employed by Moeller International Corp. in the aforementioned Skycar. Other ducted fan units are disclosed in the aforementioned U.S. Pat. No. 6,179,247.

Because of the redundancy of thrusters, the loss of power in one thruster on each side would not result in a catastrophic failure of lift. By increasing the thrust of the remaining thrusters on the side where the failure occurred, the craft will remain under control and can be lowered safely to the ground.

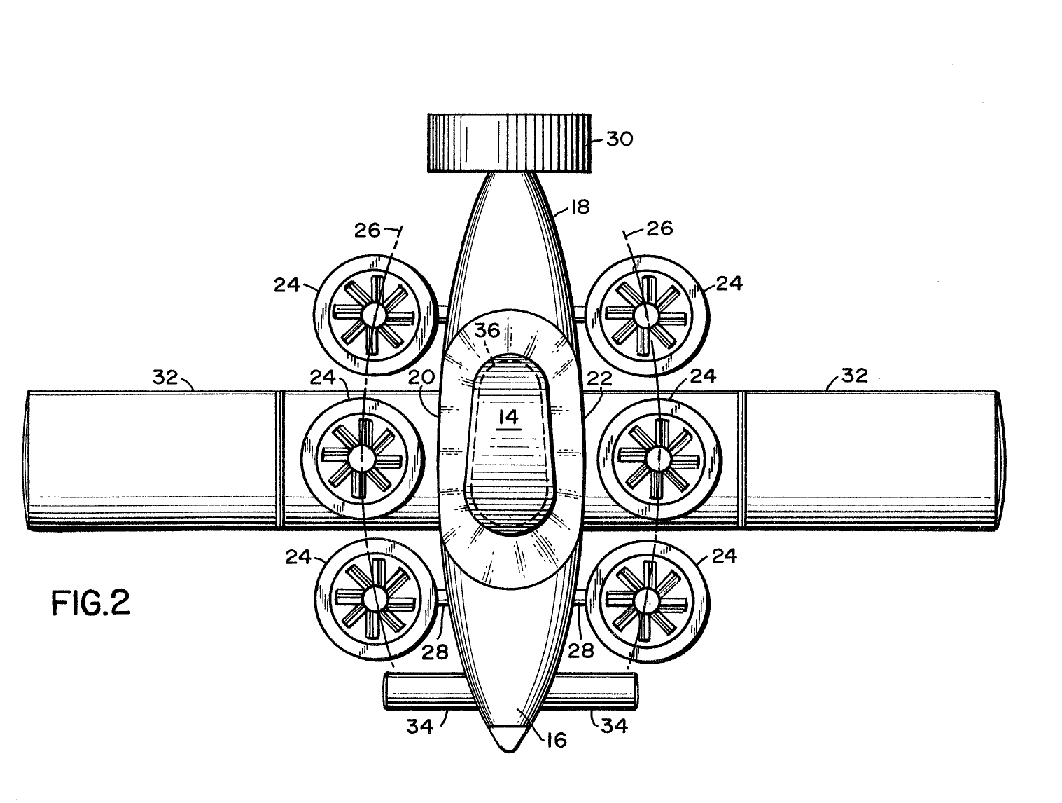

As shown in FIG. 2, the central, rotational axes of the thrusters 24 are arranged along a curved line 26 which follows the outward curve of the fuselage. Alternatively, the axes of the thrusters may be arranged along a straight line, so that the thrusters lie one behind the other in the direction of travel thus minimizing drag.

Preferably, the amount of thrust generated by each of the thrusters is independently controllable by the pilot, or by a computer, in the passenger compartment. This allows the pilot, or computer, to adjust the thrust of the remaining thrusters in case of a failure of one or more thrusters.

According to a preferred feature of the invention, the forward thrusters 24 (or rearward thrusters, or all the thrusters) are arranged on a pivot 28 and can be tilted or rotated about the pivot to adjust the direction of force which these thrusters apply to the passenger compartment. Rotating the forward thrusters counterclockwise from the vertical position increases the forward force applied to the compartment; rotating them counterclockwise from the vertical position increases the reverse force applied to the compartment.

Preferably also, the PAC is provided with an additional fan 30, either ducted or non-ducted, arranged at either the front, the rear or both the front and rear of the passenger compartment, to exert a force in the horizontal direction. In flight, this thruster 30 provides the principal lateral motivating force to the craft.

When the PAC is moving in the forward direction, it is possible to take advantage of its motion through the air to add lift to the vertical forces generated by the thrusters 24. This lift is effected by a pair of conventional wings 32 extending from each side of the passenger compartment 12. As may be seen in FIGS. 1 and 2, the wings 32 preferably surround the center thrusters 24 and are open at the top to allow air to enter these thrusters.

In order to save space when the PAC is stored or garaged on the ground, the wings 32 may be folded upward toward the passenger compartment, as is best illustrated in FIG. 4.

In addition, for control purposes, a stabilizing wing or canard 34 may be provided at the front of the fuselage. Alternatively or in addition, a rear stabilizer, and also a rudder, may be provided at the rear of the passenger compartment.

To provide an extra measure of safety, the PAC also preferably includes a parachute unit 36 disposed at the top 14 of the passenger compartment. This parachute unit 36 is arranged in line with the center of gravity of the craft. At the press of a button within the passenger compartment, means, such as a solid fuel rocket, are ignited to lift the parachute out of its compartment for deployment in the air.

There has thus been shown and described a novel personal aircraft (PAC) which fulfills all the objects and advantages sought therefor. Many changes, modifications, variations and other uses and applications of the subject invention will, however, become apparent to those skilled in the art after considering this specification and the accompanying drawings which disclose the preferred embodiment thereof. All such changes, modifications, variations and other uses and applications which do not depart from the spirit and scope of the invention are deemed to be covered by the invention, which is to be limited only by the claims which follow.

What is claimed is:

1. A personal aircraft (PAC) capable of vertical take-off and landing (VTOL) and comprising, in combination:
(a) a passenger compartment having a top, a front, a rear and two sides;
(b) a plurality of independently powered thrusters attached to the outer periphery of said compartment, with at least three thrusters disposed on each side of said compartment, said thrusters being capable of exerting a vertically upward force to said compartment.

2. The PAC defined in claim 1, wherein said three or more thrusters on each side are arranged equidistant from each other.

3. The PAC defined in claim 1, wherein said three or more thrusters on each side are arranged in a straight line.

4. The PAC defined in claim 1, wherein said three or more thrusters on each side are arranged in a curved line .

5. The PAC defined in claim 1, wherein the force of each of said thrusters is independently controllable from said compartment.

6. The PAC defined in claim 1, wherein at least one of said three or more thrusters on each side may be tilted to adjust the direction of force applied to said compartment.

7. The PAC defined in claim 1, further comprising an additional independently powered thruster attached to said compartment at one of said front and said rear to exert a force to said compartment in the horizontal direction.

8. The PAC defined in claim 1, further comprising at least one substantially horizontal wing on each side of said compartment to provide a lifting force during forward movement of the craft.

9. The PAC defined in claim 8, wherein at least two of said wings are foldable toward and away from said compartment to reduce the space required for the craft when it is on the ground.

10. The PAC defined in claim 8, comprising at least two substantially horizontal wings on each side of said craft.

11. The PAC defined in claim 1, wherein a plurality of said thrusters comprise a ducted fan and a prime mover for driving the fan.

12. The PAC defined in claim 1, further comprising a parachute attached to the top of said compartment, and means for deploying said parachute.
